(19) United States
(12) Patent Application Publication
(10) Pub. No.: US 2022/0051320 A1
(43) Pub. Date: Feb. 17, 2022

(54) METHOD AND SYSTEM FOR VALIDATING TRANSACTION SETTLEMENTS

(71) Applicant: JPMorgan Chase Bank, N.A., New York, NY (US)

(72) Inventors: Prasad P CHAUBAL, Dayton, NJ (US); Sachin Narhari KATAKDOUND, Edison, NJ (US); Matthew YAZDI, Scarsdale, NY (US)

(73) Assignee: JPMorgan Chase Bank, N.A., New York, NY (US)

(21) Appl. No.: 16/992,562

(22) Filed: Aug. 13, 2020

(51) Int. Cl. G06Q 40/04; G06Q 20/40; G06N 20/00; G06N 5/04

(52) U.S. Cl. CPC G06Q 40/04; G06N 5/04; G06N 20/00; G06Q 20/40

(57) ABSTRACT

A method and a system for validating a completeness and correctness of information required for a proposed transaction in order to facilitate a successful and timely settlement of the transaction is provided. The method includes: receiving a request for a proposed transaction that includes information that relates to the proposed transaction; and determining whether the information is sufficient for executing the proposed transaction and whether the information includes an error that would prevent a successful execution of the proposed transaction. The determinations regarding sufficiency and presence of errors may be made by applying one or more algorithms based on machine learning techniques. When the information is found to be insufficient or to include errors, proposed actions for remedying the problems are provided.

### BACKGROUND

### 1. Field of the Disclosure

This technology generally relates to methods and systems for validating transaction settlements, and more particularly, to methods and systems for validating a completeness and correctness of information required for a proposed transaction in order to facilitate a successful and timely settlement of the transaction.

### 2. Background Information

Financial institutions, such as banks and investment brokerage firms, execute many transactions on behalf of clients on a daily basis. Such transactions often involve trading securities and/or other instruments on markets.

In many instances, a proposed transaction is time-sensitive, because if the transaction is not successfully completed within a particular interval of time, a penalty may be applied and/or a significant financial loss may occur, thus resulting in a liability to the financial institution. However, if the proposed transaction is based on incomplete or incorrect information, then the transaction cannot be executed successfully. In this aspect, checking the information for completeness and correctness may be time-consuming which is problematic when the volume of proposed transactions is large.

Accordingly, there is a need for a method and a system for validating a completeness and correctness of information required for a proposed transaction in order to facilitate a successful and timely settlement of the transaction.

### SUMMARY

The present disclosure, through one or more of its various aspects, embodiments, and/or specific features or sub-components, provides, inter alia, various systems, servers, devices, methods, media, programs, and platforms for validating a completeness and correctness of information required for a proposed transaction in order to facilitate a successful and timely settlement of the transaction.

According to an aspect of the present disclosure, a method for validating a completeness and correctness of information required for a proposed transaction in order to facilitate a successful and timely settlement of the transaction is provided. The method is implemented by at least one processor. The method includes: receiving, from a user by the at least one processor, a request for a proposed transaction, the request including first information that relates to the proposed transaction; determining, by the at least one processor, whether the first information is sufficient for executing the proposed transaction; determining, by the at least one processor, whether the first information includes at least one error that would prevent a successful execution of the proposed transaction; when the first information is determined as sufficient for executing the proposed transaction and as not including the at least one error, validating by the at least one processor, the first information; and when the first information is validated, transmitting, to the user by the at least one processor, a validation notification that the first information is validated for execution of the proposed transaction.

The determining of whether the first information is sufficient for executing the proposed transaction may include applying a first algorithm that relates to a first machine learning technique to the first information.

When the first information is determined as not sufficient for executing the proposed transaction, the method may further include transmitting, to the user, an insufficiency notification that additional information is required.

The insufficiency notification may include second information that relates to a proposed action for supplementing the first information to be sufficient for executing the proposed transaction.

The applying of the first algorithm may include providing historical transaction data as an input to the first algorithm, and generating the second information that relates to the proposed action as an output of the first algorithm.

The determining of whether the first information includes the at least one error may include applying a second algorithm that relates to a second machine learning technique to the first information.

When the first information is determined as including the at least one error, the method may further include transmitting, to the user, an error notification that relates to the at least one error.

The error notification may include third information that relates to a proposed action for remedying the at least one error such that the successful execution of the proposed transaction would not be prevented.

The applying of the second algorithm may include providing historical transaction data as an input to the second algorithm, and generating the third information that relates to the proposed action as an output of the second algorithm.

The first information may include at least one from among an identification of a security to be traded in the proposed transaction, a number of shares of the security to be traded in the proposed transaction, an amount of currency to be exchanged in the proposed transaction, and a timing for execution of the proposed transaction.

According to another exemplary embodiment, a computing apparatus for validating a completeness and correctness of information required for a proposed transaction in order to facilitate a successful and timely settlement of the transaction is provided. The computing apparatus includes a processor, a memory, and a communication interface coupled to each of the processor and the memory. The processor is configured to: receive, from a user via the communication interface, a request for a proposed transaction, the request including first information that relates to the proposed transaction; determine whether the first information is sufficient for executing the proposed transaction; determine whether the first information includes at least one error that would prevent a successful execution of the proposed transaction; when the first information is determined as sufficient for executing the proposed transaction and as not including the at least one error, validate the first information, and when the first information is validated, transmit, to the user via the communication interface, a validation notification that the first information is validated for execution of the proposed transaction.

The processor may be further configured to determine whether the first information is sufficient for executing the proposed transaction by applying a first algorithm that relates to a first machine learning technique to the first information.

When the first information is determined as not sufficient for executing the proposed transaction, the processor may be further configured to transmit, to the user via the communication interface, an insufficiency notification that additional information is required.

The insufficiency notification may include second information that relates to a proposed action for supplementing the first information to be sufficient for executing the proposed transaction.

The processor may be further configured to provide historical transaction data as an input to the first algorithm, and to generate the second information that relates to the proposed action as an output of the first algorithm.

The processor may be further configured to determine whether the first information includes the at least one error by applying a second algorithm that relates to a second machine learning technique to the first information.

When the first information is determined as including the at least one error, the processor may be further configured to transmit, to the user via the communication interface, an error notification that relates to the at least one error.

The error notification may include third information that relates to a proposed action for remedying the at least one error such that the successful execution of the proposed transaction would not be prevented.

The processor may be further configured to provide historical transaction data as an input to the second algorithm, and to generate the third information that relates to the proposed action as an output of the second algorithm.

The first information may include at least one from among an identification of a security to be traded in the proposed transaction, a number of shares of the security to be traded in the proposed transaction, an amount of currency to be exchanged in the proposed transaction, and a timing for execution of the proposed transaction.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for validating a completeness and correctness of information required for a proposed transaction in order to facilitate a successful and timely settlement of the transaction.

FIG. 4 is a flowchart of an exemplary process for implementing a method for validating a completeness and correctness of information required for a proposed transaction in order to facilitate a successful and timely settlement of the transaction.

FIG. 5 is a data flow diagram that illustrates how data is communicated between components of a system for implementing a method for validating a completeness and correctness of information required for a proposed transaction, according to an exemplary embodiment.

FIG. 6 is a data flow diagram that illustrates how data is communicated between the system of FIG. 5 and an external server, according to an exemplary embodiment.

FIG. 7 is a flow chart data flow diagram that illustrates an exemplary process for implementing a method for validating a completeness and correctness of information required for a proposed transaction, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

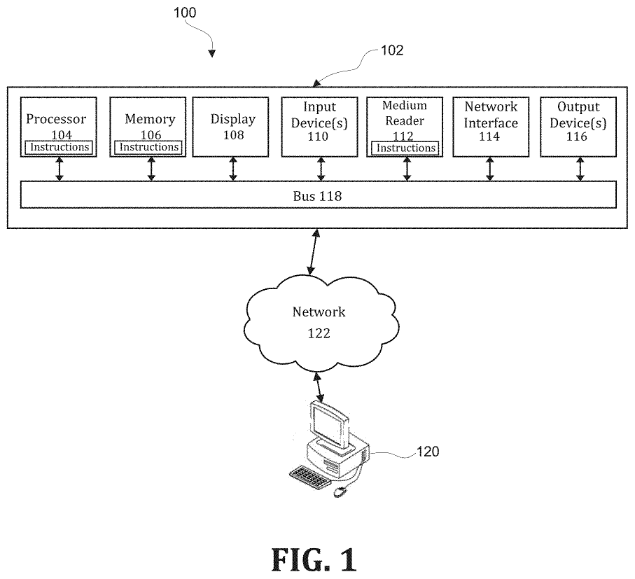

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for validating a completeness and correctness of information required for a proposed transaction in order to facilitate a successful and timely settlement of the transaction.

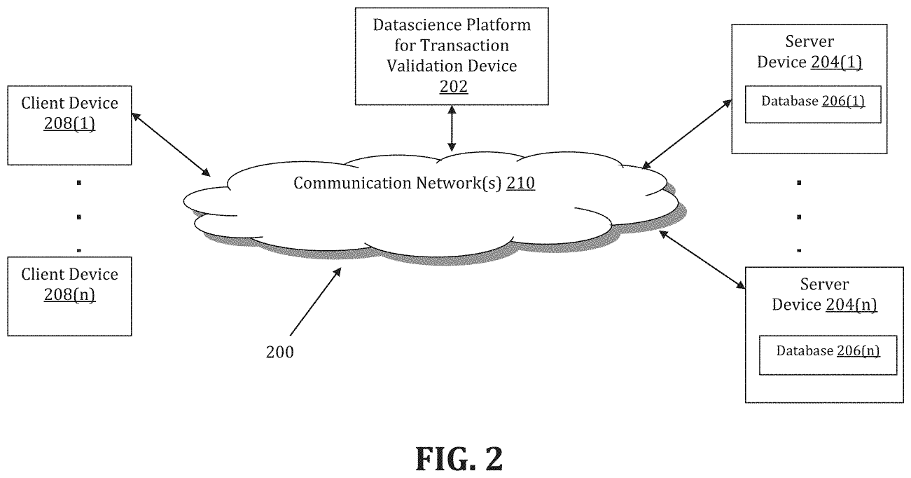

Referring to FIG. 2, a schematic of an exemplary network environment 200 for implementing a method for validating a completeness and correctness of information required for a proposed transaction in order to facilitate a successful and timely settlement of the transaction is illustrated. In an exemplary embodiment, the method is executable on any networked computer platform, such as, for example, a personal computer (PC).

The method for validating a completeness and correctness of information required for a proposed transaction in order to facilitate a successful and timely settlement of the transaction may be implemented by a Datascience Platform for Transaction Validation (DPTV) device 202. The DPTV device 202 may be the same or similar to the computer system 102 as described with respect to FIG. 1. The DPTV device 202 may store one or more applications that can include executable instructions that, when executed by the DPTV device 202, cause the DPTV device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DPTV device 202 itself may be located in virtual server(s) running in a cloud-based computing environment rather than being tied to one or more specific physical network computing devices. Also, the application(s) may be running in one or more virtual machines (VMs) executing on the DPTV device 202. Additionally, in one or more embodiments of this technology, virtual machine(s) running on the DPTV device 202 may be managed or supervised by a hypervisor.

In the network environment 200 of FIG. 2, the DPTV device 202 is coupled to a plurality of server devices 204(1)-204(n) that hosts a plurality of databases 206(1)-206(n), and also to a plurality of client devices 208(1)-208(n) via communication network(s) 210. A communication interface of the DPTV device 202, such as the network interface 114 of the computer system 102 of FIG. 1, operatively couples and communicates between the DPTV device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DPTV device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DPTV devices that efficiently implement a method for validating a completeness and correctness of information required for a proposed transaction in order to facilitate a successful and timely settlement of the transaction.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DPTV device 202 may be a standalone device or integrated with one or more other devices or apparatuses, such as one or more of the server devices 204(1)-204(n), for example. In one particular example, the DPTV device 202 may include or be hosted by one of the server devices 204(1)-204(n), and other arrangements are also possible. Moreover, one or more of the devices of the DPTV device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DPTV device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store historical transaction data and artificial intelligence/machine learning model data that relates to forecasting user actions in connection with proposed and recently completed transactions.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DPTV device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DPTV device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DPTV device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DPTV device 202, the server devices 204(1)-204(n), or the client devices 208(1)-208(n), for example, may be configured to operate as virtual instances on the same physical machine. In other words, one or more of the DPTV device 202, the server devices 204(1)-204(n), or the client devices 208(1)-208(n) may operate on the same physical device rather than as separate devices communicating through communication network(s) 210. Additionally, there may be more or fewer DPTV devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

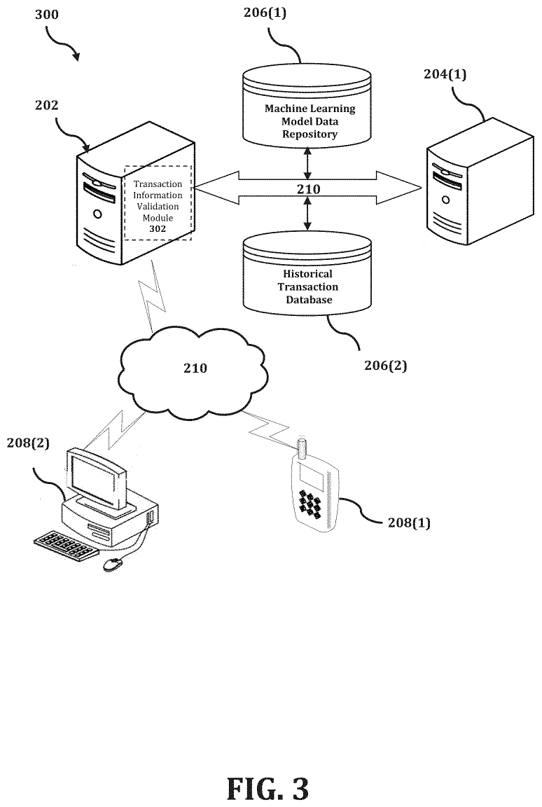

The DPTV device 202 is described and shown in FIG. 3 as including a transaction information validation module 302, although it may include other rules, policies, modules, databases, or applications, for example. As will be described below, the transaction information validation module 302 is configured to implement a method for validating a completeness and correctness of information required for a proposed transaction in order to facilitate a successful and timely settlement of the transaction in an automated, efficient, scalable, and reliable manner.

An exemplary process 300 for implementing a method for validating a completeness and correctness of information required for a proposed transaction in order to facilitate a successful and timely settlement of the transaction by utilizing the network environment of FIG. 2 is shown as being executed in FIG. 3. Specifically, a first client device 208(1) and a second client device 208(2) are illustrated as being in communication with DPTV device 202. In this regard, the first client device 208(1) and the second client device 208(2) may be “clients” of the DPTV device 202 and are described herein as such. Nevertheless, it is to be known and understood that the first client device 208(1) and/or the second client device 208(2) need not necessarily be “clients” of the DPTV device 202, or any entity described in association therewith herein. Any additional or alternative relationship may exist between either or both of the first client device 208(1) and the second client device 208(2) and the DPTV device 202, or no relationship may exist.

Further, DPTV device 202 is illustrated as being able to access a machine learning model data repository 206(1) and a historical transaction database 206(2). The transaction information validation module 302 may be configured to access these databases for implementing a method for validating a completeness and correctness of information required for a proposed transaction in order to facilitate a successful and timely settlement of the transaction.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DPTV device 202 via broadband or cellular communication. Of course, these embodiments are merely exemplary and are not limiting or exhaustive.

Upon being started, the transaction information validation module 302 executes a process to validating a completeness and correctness of information required for a proposed transaction in order to facilitate a successful and timely settlement of the transaction. A trade transaction has multiple counterparties that affect the overall and specific set of information details in a given transaction record, including a Client that provides instructions to the transaction information validation module 302, a Clearing Broker or Executing Broker that feeds the information into matching engines and to a central depository, i.e., machine learning model data repository 206(1), and the actual counterparty that acts on the opposite side of the transaction. The completeness and correctness of the information check is valid for the given stage of the transaction lifecycle present at that point in time, thus making it a more complex and time consuming process for manual handling.

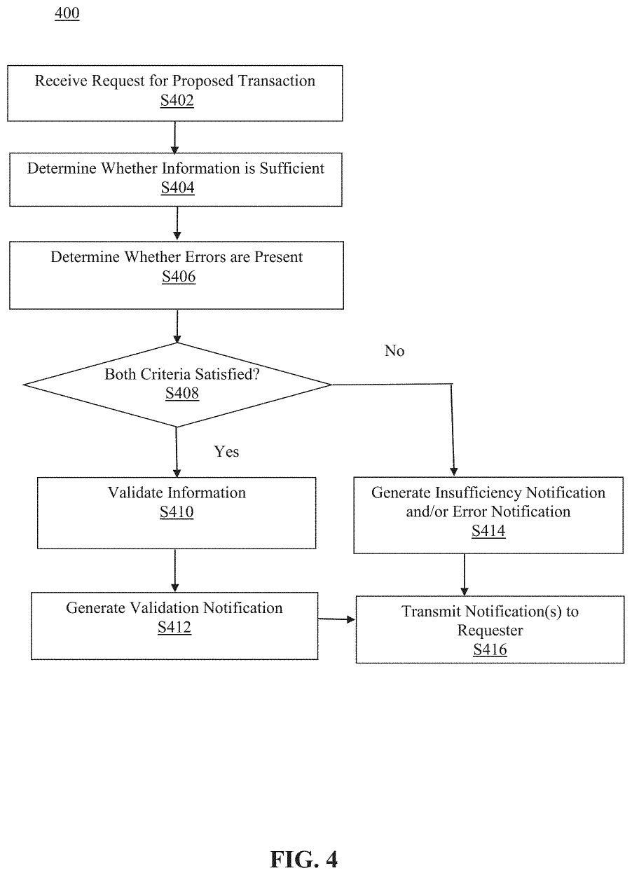

An exemplary process for validating a completeness and correctness of information required for a proposed transaction in order to facilitate a successful and timely settlement of the transaction is generally indicated at flowchart 400 in FIG. 4.

In the process 400 of FIG. 4, at step S402, the transaction information validation module 302 receives a request for a proposed transaction from a user. The request includes first information that relates to the proposed transaction, such as, for example, an identification of a security to be traded, a number of shares of the security, an amount of currency to be exchanged, and/or a timing for execution of the proposed transaction. Irrespective of the trade mechanics, as soon as a trade is received, a process-specific categorization is performed, in order to facilitate an identification of an appropriate step in which the trade may be placed with respect to the overall trade lifecycle steps. This categorization and historical transitions to other meaningful categories are exploited extensively by using machine learning techniques to recommend the next step.

At step S404, the transaction information validation module 302 determines whether the first information is sufficient for executing the proposed transaction, i.e., whether additional information is required. In an exemplary embodiment, the transaction information validation module 302 applies a first algorithm that is based on one or more machine leaning techniques to the first information in order to determine whether the information is sufficient for execution of the proposed transaction. The first algorithm may be trained by using historical transaction data. The data collection strategy combines user actions together with trade details in order to identify historical categories and their transition patterns.

At step S406, the transaction information validation module 302 determines whether the first information includes any errors that would prevent a successful execution of the proposed transaction. In an exemplary embodiment, the transaction information validation module 302 applies a second algorithm that is based on one or more machine learning techniques to the first information in order to determine whether the information has errors. The second algorithm may also be trained by using historical transaction data.

At step S408, the transaction information validation module 302 determines whether or not to validate the first information based on a result of steps S404 and S406. When the first information is determined as being sufficient for executing the proposed transaction and as not including any errors, (i.e., Yes at step S408), then at step S410, the transaction information validation module 302 validates the first information, and at step S412, a validation notification message indicating that the first information is validated is generated.

When the first information is determined as not satisfying both criteria for validation (i.e., No at step S408), then at step S414, a notification message that indicates either or both of an insufficiency and an error is generated. In an exemplary embodiment, when the first information is determined as not being sufficient for executing the proposed transaction, an insufficiency notification indicating that additional information is required is generated, and when the first information is determined as including errors, an error notification indicating the presence of errors is generated.

In an exemplary embodiment, the insufficiency notification includes second information that indicates a proposed action for supplementing the first information in order to remedy the insufficiency. The proposed action may be generated as an output of the first algorithm applied in step S404. Analysis and correlation of trade and other attributes (such as, for example, attributes that are specific to the Client, the Clearing Broker or Executing Broker, and/or the actual counterparty) in the data are performed in order to identify factors that are important for determining the proposed user action.

In an exemplary embodiment, the error notification includes third information that indicates a proposed action for remedying the error(s) such that the execution of the proposed transaction would not be prevented. The proposed action may be generated as an output of the second algorithm applied in step S406.

At step S416, the notification message(s) generated in either step S412 or S414 are transmitted to the user that submitted the request in step S402.

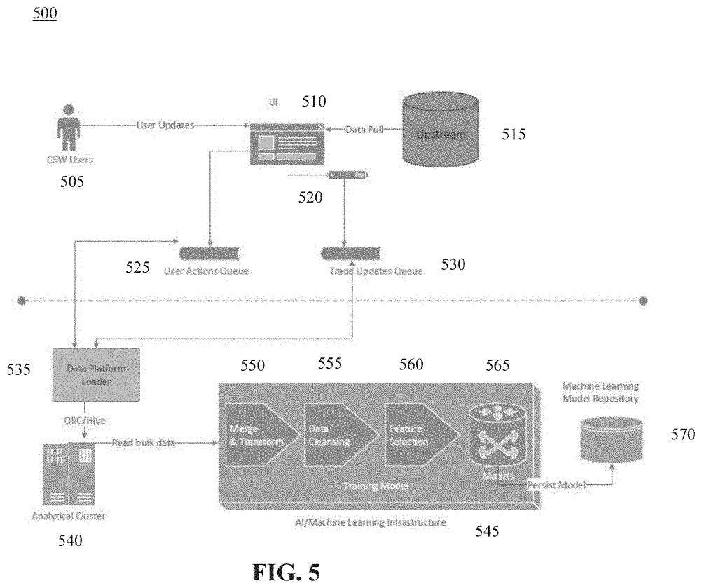

FIG. 5 is a data flow diagram 500 that illustrates how data is communicated between components of a system for implementing a method for validating a completeness and correctness of information required for a proposed transaction, according to an exemplary embodiment. Client service workstation (CSW) user 505 provides user updates to a user interface (UI) 510, which also is able to display data retrieved from upstream database 515. When a request for executing a proposed transaction is received, the request is transmitted from UI 510 via user actions queue 525 to data platform loader 535, and the information provided with the request is forwarded to analytical cluster 540. The information is then analyzed by using artificial intelligence (AI)/machine learning infrastructure 545 to apply one or more algorithms to the information. The AI/machine learning infrastructure 545 includes a repetitive training process that generates a model 565, and the model 565 is prepared by following multiple sequential steps. According to an exemplary embodiment, these steps may include a merge & transform module 550, a data cleansing module 555, and a feature selection module 560. Once the model 565 is prepared, it is saved into a machine learning model repository 570, such as, for example, a model database 570 that is in communication with the AI/machine learning infrastructure 545.

Any additional changes in upstream system 515 that indicate the change in the trade details as those trades are executed by other participants and systems are sent by UI 510 to a trade updates queue 530. This is then communicated to the data platform loader 535 from trade updates queue 530, which is connected to an external network (e.g., a local area network or the Internet) via router 520. The result may include a validation notification to indicate that the information has been validated and the proposed transaction may be executed. Alternatively, the result may include an insufficiency notification to indicate that more information is required, and/or an error notification to indicate that the information has an error. Proposed actions for remedying the insufficiency and/or the error may also be indicated.

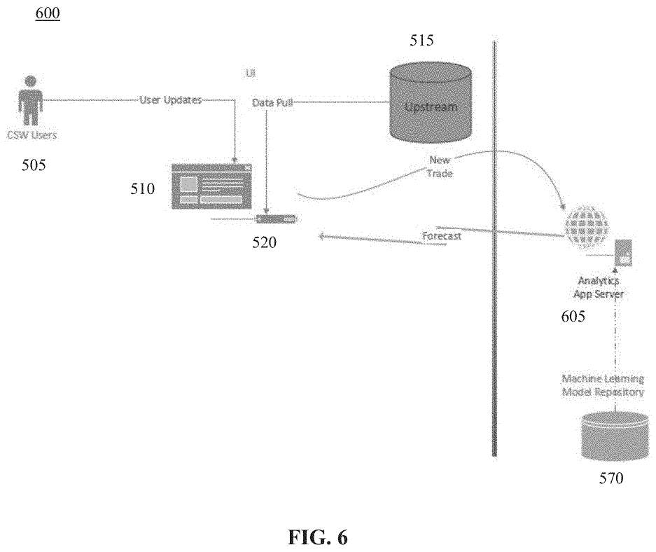

FIG. 6 is a data flow diagram 600 that illustrates how data is communicated between the system of FIG. 5 and an external server, according to an exemplary embodiment. Client service workstation (CSW) user 505 provides user updates to UI 510, which also is able to display data retrieved from upstream database 515. An external analytics application server 605 may receive information that relates to a new trade from UI 510 via router 520. The analytics application server 605 is in communication with machine learning model repository 570, and may use data obtained therefrom to analyze the new trade and to generate a forecast based on a result of the analysis. The forecast may then be transmitted to the UI 510 via router 520.

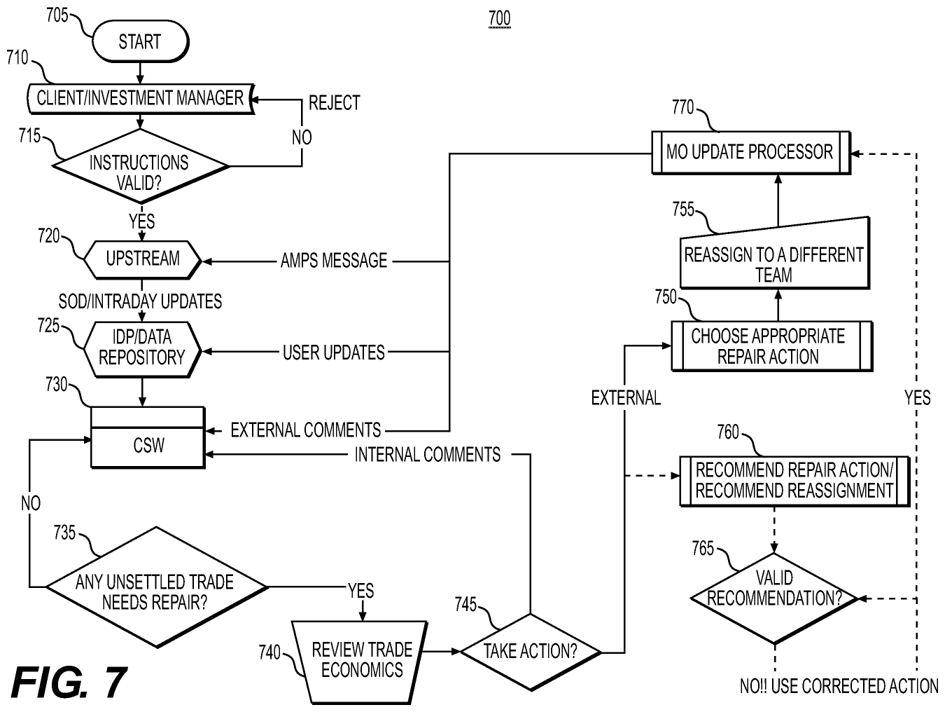

FIG. 7 is a flow chart data flow diagram 700 that illustrates an exemplary process for implementing a method for validating a completeness and correctness of information required for a proposed transaction, according to an exemplary embodiment. The process starts at step 705. At step 710, a request for execution of a proposed transaction is generated by a client or an investment manager. At step 715, the instructions provided with the request are checked for validity, and if they are not valid, the process returns to step 710. If the instructions are valid, then at step 720, the request is forwarded to an upstream database 720 to obtain intraday updates, and the updated request is then forwarded to an identity provider (IDP)/data repository 725 and a client service workstation (CSW) 730.

At step 735, a determination is made as to whether any information included with the request requires repair, i.e., whether the information is sufficient for executing the proposed transaction and whether the information includes any errors that would prevent a successful execution of the proposed transaction. If no repair is required, then the process returns to CSW 730 in order to proceed with execution of the transaction.

If a repair is required, then at step 740, a review of the trade economics is performed with respect to the proposed transaction in order to effectively diagnose a problem, i.e., an insufficiency of information and/or an error included in the information. At step 745, a determination is made whether to take an action to remedy the problem. If no action is to be taken, then the process returns to CSW 730, and internal comments are transmitted to CSW 730 to inform the user of a result of the review of the trade economics.

If an action is indicated, then there are two process paths: First, at step 750, an appropriate repair action is chosen, and at step 755, the request is reassigned to a different team that is suitable for performing the selected repair action. Alternatively, instead of steps 750 and 755, the process may proceed to step 760 at which an appropriate repair action is recommended and a reassignment team is recommended, and then to step 765, at which a determination is made regarding whether the recommendations are valid.

After the repair action has been completed, the process proceeds to an update processor 770, which then generates one or more notification messages and returns to an earlier step in the process in order to attempt an execution of the proposed transaction based on the completed repair action. In particular, the update processor 770 may generate an Advanced Message Processing System (AMPS) message and then transmit the AMPS message to upstream database 720; the update processor may generate a user update and then transmit the user update to the IDP/data repository 725; and/or the update processor may generate external comments and then transmit the comments to CSW 730.

In an exemplary embodiment, algorithms that relate to machine learning techniques are trained by using data that corresponds to a list of features and/or attributes of data that may be included in a request for execution of a proposed transaction. The list of features and/or attributes may include one or more of the following, as provided in Table 1:

TABLE 1
Features/Attributes

Trade ID
Investment Manager Name
Account Number
Account Name
Trading Broker Name
Financial Institution ID
Contra Account
Contra Description
ECID
High Value/Quantity
Client Comments
Broker Short Name
Assigned To
RAG
Side
ISIN
Quantity
Net Amount
Currency Desc
Trade Date
Contractual Settlement Date
Market
Asset Servicing Indicator
Settlement Age
Settlement Age Category
Settlement Age Days
Bank Status Narrative
Fail Narrative 2
Internal Comments
Status
Fail Code
Status Category
CUSIP
Location/Nominee Code
Sub Account Number
Update Pending
Price
Principal Cash Amount
Security Identifier
Focus Client
Primary Coverage Region
Custody MO NA Coverage: Team
Custody MO Japan Coverage
Custody MO Japan Coverage: Team
Broker Comments
Custody MO NA Coverage
Custody MO EMEA Coverage
Custody MO EMEA Coverage: Team
Trade input Date
Value Date
Actual Settlement Date
Sub Account Name
Sub Account Type Description
Security Description
Asset Type Code
Security Type
Processing Location Code
Agent Cut Off Time
OMS/AF Integration Flag
Investment Manager Code
VET FX Ind
VET Special Instruction
SWIFT Fail Code
Call Broker
Broker MENA Coverage
Broker MENA Coverage: Team
External Comments
Financial Institution Agent Account Number
Broker NA Coverage: Team
Broker NA Coverage
Broker EMEA Coverage
Broker EMEA Coverage: Team
Broker APAC Coverage
Broker APAC Coverage: Team
CORE Source System
AME Indicator
Fail Code Flag
BULK/CHILD
Unprocessed Age
Unprocessed Age Days
Hold/Release
Security Lending Type
Overlent
UCN Name
Market Instruction Reference
Market Comments
Contingent Link Reference
Maximum Linked Trades
Asset Transition
Contingent Linking Trade Type
VET Transaction Status
VET Transaction Sub Status
VET Instruction Receipt TimeStamp
VET Validation Failures
TRE FIFO Queue Status
TRE Available Vault
TRE Actual Vault
TRE Release Status
TRE FIFO Status
TRE Priority
TRE Last Updated By
TRE Comments
TRE Comments User ID
TRE Comments Time Stamp
TRE Updated Time Stamp
VET Orphan Cancel Ind
Inter Account Trade Indicator
Contingent Link Reference Enriched
Possible Contingent Link
Last Comment Updated User ID
CAID
Last Comment Updated Timestamp
FMT Action Required
Safekeeping Account
Clearing Broker Account
COSMIC Tran Type Description
COSMIC Tran Type
Cosmic Customer Ref No
Legal Entity
Location/Nominee Name
Clearing Broker Name
Delivery Method
Transaction Category Description
Trade Matched Date
Transaction Type Description
Client ID
FX Contra Amount
FX Currency Code
FX Detail
Currency
Trade Input Time
Instruction Date
Transaction Last Update Date
Transaction Last Update Time
Trade Special Instruction Narrative
Trade Special Instruction Trade ID
Special Instruction Ind
UCN ID
Principal
Net Amount-USD Equiv
STP Status Description
STP Status
VET Status Description
VET Status
Bank Reference
Clearing Broker Code
Bulk Trade ID
By Order of
Cable Advise
Cash Transaction Type Description
Collateral Account
ID Market
Instruction Sender
Relationship Code Name
Source System
SWIFT Narrative
Trade Instruction Narrative
Trade Instruction Trade ID
Value Added Tax
Repo ID
Beneficiary
Sensitive Market
Cash Settlement Code Description
Client BIC
Commision Amount
Commission Currency Code
Contract Number
Contract Stamp Amount
Core Post Date
Country National Federal Tax

In an exemplary embodiment, the algorithms that relate to machine learning techniques may generate, as an output, one or more proposed actions for remedying a problem, such as an insufficiency of information included in a request for execution of a proposed transaction or a presence of an error that would prevent a successful execution of the proposed transaction. Table 2 includes a list of examples of proposed actions for remedying such a problem:

TABLE 2
Examples of Proposed Actions

Overdrawn (OD) due to purchase trade on cusip/sedol #1# the amount #1# under ref #1# for
trade date #3# and Settlement Date #2#
OD increased due to payment in the amount #1# made to #1# under reference #1# for value date #2#
OD decreased due to receipt in the amount #1# receiving from #1# under reference #1# for value
date #2#
OD due to cable payment order in the amount #1# made to #1# under reference #1# for value date #2#
OD increased due to cable payment order in the amount #1# made to #1# under reference #1# for
value date #2#
OD decreased due to cable payment order in the amount #1# receiving from #1# under
reference #1# for value date #2#
OD due to MISCELLANEOUS DEBIT #1# in the amount #1# for value date #2#
OD increased due to MISCELLANEOUS DEBIT #1# in the amount #1# for value date #2#
OD decreased due to MISCELLANEOUS CREDIT #1# in the amount #1# for value date #2#
OD due to non receipt in the amount #1# for value date #2#
OD increased due to non receipt in the amount #1# for value date #2#
OD increased due to purchase trade on cusip/sedol #1# the amount #1# under ref #1# for trade
date #3# and Settlement Date #2#
OD due to Redemption #1# in the amount #1# for value date #2#
OD increased due to Redemption #1# in the amount #1# for value date #2#
OD due to Corporate action on #1# in the amount #1# for value date #2#
OD increased due to Corporate action on #1# in the amount #1# for value date #2#
OD decreased due to Corporate action on #1# in the amount #1# for value date #2#
OD due to Debit interest charged in the amount #1# for value date #2#
OD due to NEGATIVE CR INTEREST charged in the amount #1# for value date #2#
OD decreased due to NEGATIVE CR INTEREST charged in the amount #1# for value date #2#
OD due to pending sale trade on cusip/sedol #1# in the amount #1# for trade date #3# and
settlement date #2#
OD increased due to pending sale trade on cusip/sedol #1# in the amount #1# for trade date #3# and
settlement date #2#
OD due to INTER ACCOUNTTRANSFER in the amount #1# made to #1# under reference #1# for
value date #2#
OD decreased due to sale trade on cusip/sedol #1# the amount #1# under ref #1# for trade date #3#
and Settlement Date #2#
OD increased due to INTER ACCOUNTTRANSFER in the amount #1# made to #1# under reference #1#
for value date #2#
OD decreased due to INTER ACCOUNTTRANSFER in the amount #1# receiving from #1#
under reference #1# for value date #2#
OD due to Cancellation of Sale trade on sedol #1# in the amount #1# for value date #2#
OD increased due to Cancellation of Sale trade on sedol #1# in the amount #1# for value date #2#
OD reduced due to Cancellation of Purchase trade on sedol #1# in the amount #1# for value date #2#
OD due to Reversal of Sale trade on Cusip #1# in the amount #1# for value date #2#
OD increased due to Reversal of Sale trade on Cusip #1# in the amount #1# for value date #2#
OD reduced due to Reversal of Purchase trade on Cusip #1# in the amount #1# for value date #2#
OD due to Pending Principal payments on Cusip #1# in the amount #1# for value date #2#
OD due to FX SOLD in the amount #1# under ref #1# for value date #2#
OD increased due to Pending Principal payments on Cusip #1# in the amount #1# for value date #2#
OD due to Pending Interest payments on Cusip #1# in the amount #1# for value date #2#
OD increased due to Pending Interest payments on Cusip #1# in the amount #1# for value date #2#
OD due to Pending Prinicpal and Interest payments on Cusip #1# in the amount #1# for value date #2#
OD increased due to Pending Prinicpal and Interest payments on Cusip#1#in the amount #1#
for value date #2#
OD decreased due to Redemption #1# in the amount #1# for value date #2#
OD increased due to Debit interest charged in the amount #1# for value date #2#
OD increased due to FX SOLD in the amount #1# under reference #1# for value date #2#
OD decreased due to FX Purchase in the amount #1# v/s contra amount #1# for value date #2#
OD due to #1# in the amount #1# under ref #1# for value date #2#
OD increased due to #1# in the amount #1# under reference #1# for value date #2#
OD due to payment in the amount #1# made to #1# under reference #1# for value date #2#
Payment cancelled due to insufficient funding. Please advise/Re-instruct.
Financial institution in non-receipt of funds. Contacted #8# on #9#. Please advise if this is a valid payment
or provide confirmation of instruction.
Funds received by financial institution Custody, Transaction will be posted to client account by #7#.
Funds received with insufficient beneficiary information. JPM working with agent bank #2#
to get further details.
Transaction is pending for Internal Review.
Funds received with insufficient beneficiary information #3#. Counterparty/Agent is
unable to amend. Please advise correct details.
Transaction pending due to insufficient funds.Current available balance is #5#.
Please advise on funding source.
Transaction will settle #6# as it is linked to Short Term Investment Fund (STIF) movement.
Settled with #4# vs Advise to Receive #4#.
Settlement date is not for valid business day/Back value date #7#. Please advise/send an
amendment with valid settlement date.
Transaction Unprocessed due to #8#. Please advise on amendment.
Unprocessed as this is a duplicate transaction #9#, Please confirm if this is a valid instruction to process.
Account mismatch as per #1# at #2#, counterparty to amend to match financial institution
Account mismatch as per #1# at #2#, knows #3#, client to advise
Account mismatch as per #1# at #2#, knows #3#, client to amend
SSI mismatch as per #1# at #2#, counterparty to amend to match financial institution
SSI mismatch as per #1# at #2#, knows #3#, client to advise
SSI mismatch as per #1# at #2#, knows #3#, client to amend
SSI mismatch as per #1# at #2#, knows SSI #3#, counterparty to amend to match financial institution
Affirmed with control number #1#
Counterparty DK's the trade as per #1# at #2# #3#
Counterparty DK's the trade as per #1# at #2# #3#
As per #1# at #2#, buy in procedures have been initiated at #1# on the trade
As per #1# at #2# buy in procedures have been initiated at #1# on the trade
Cash mismatch as per #1# at #2#, knows settlement amount #3# #4#
Cash mismatch as per #1# at #2#, knows settlement amount #3#, client to amend #4#
Cash mismatch as per #1# at #2#, knows settlement amount #3#, counterparty to
amend to match financial institution
Security mismatch as per #1# at #2#, knows #3#, counterparty to amend to
match financial institution
Cash mismatch as per #1# at #2#, knows settlement amount #3#, counterparty to
amend to match JPM
Quantity mismatch as per #1# at #2#, knows #3#, counterparty to amend to match
financial institution
Market mismatch as per #1# at #2#, knows #3#, counterparty to amend to match
financial institution
Settlement date mismatch as per #1# at #2#, knows #3#, counterparty to amend to match
financial institution
Direction of trade mismatch as per #1# at #2#, knows #3#, counterparty to amend to match
financial institution
Settlement terms mismatch as per #1# at #2#, counterparty knows #3#, counterparty to amend
to match financial institution
Trade date mismatch as per #1# at #2#, knows #3#, counterparty to amend to match
financial institution
Pending credit check release due to insufficient funding. Client to advise
Pending credit check release due to insufficient funding. Awaiting proceeds from failing sale trade #1#
Pending credit check release due to insufficient funding. Client to advise
Pending credit check release due to insufficient funding. Awaiting proceeds from failing sale trade #1#
Partial settlement offered by #1# at #2# with quantity #3# cash #4#
Partial settlement offered by #1# at #2# with quantity #3# cash #4#
Contacted #1# at #2#, awaiting response
Contacted #1# at #2#, awaiting response
CUSIP is chilled in market. Checking with DTCC if the CUSIP #1# is eligible for frozen letter movement
CUSIP is chilled in market. Frozen letter initiated and working with CP to settle
CUSIP is chilled in market. Checking with DTCC if the CUSIP #1# is eligible for frozen letter movement
CUSIP is chilled in market. Frozen letter initiated and working with counterparty to settle
CUSIP is chilled due to Corporate action #1#
CUSIP is chilled due to Corporate action #1#
Counterparty has insufficient shares to deliver as per #1# at #2#
Prematched with #1# at #2# and they have agreed on the trade details
Settlement date mismatch as per #1# at #2#, knows #3#
Direction of trade mismatch as per #1# at #2#, knows #3#
Trade rejected due to minimum denomination issue, per market it should be #1#
and the par on trade is #1#
Trade rejected due to minimum denomination issue, per market it should be #1#
and the par on trade is #1#
Market mismatch as per #1# at #2#, knows #3#
Market mismatch as per #1# at #2#, knows #3#
Market mismatch as per #1# at #2#, knows #3#, client to amend
Market mismatch as per #1# at #2#, knows #3#, counterparty to amend to match financial institution
DRS/DWAC trade, transfer agent has rejected the instruction stating #1#
DRS/DWAC trade, No contact at Transfer Agent. Please provide contact for follow up
DRS/DWAC contacted #1# at #2# for an update-awaiting response
DRS/DWAC approved-Awaiting settlement
DRS/DWAC approved-Awaiting settlement
DTC adjustment trade, awaiting counterparty to accept as per #1# at #2#
Possible duplicate with trade #4#. Client to advise
Possible duplicate with trade #4#. Client to advise
Settlement terms mismatch as per #1# at #2#, counterparty knows #3#, client to amend
Future delivery date #1#
Future delivery date #1#
Inter account transfer, we are missing #1#
Incorrect buyer or seller, allegement in the market is from #1# at #2#, client to advise
Incorrect buyer or seller, trade booked with #1# but allegement in the market is from #1#, client to advise
Counterparty has insufficient shares to deliver as per #1# at #2#
Client has insufficient shares to deliver, client to advise
Client has insufficient shares to deliver-This trade is contingent on purchase trade #1#
Client has insufficient shares to deliver-shares are on loan. Directed lending team to recall the shares.
Client has insufficient shares to deliver-shares are on loan. Directed lending team to recall the shares.
Client has insufficient shares to deliver-shares are on loan. Discretionary lending team to recall the shares.
Client has insufficient shares to deliver-shares are on loan. Discretionary lending team to recall the shares.
SSI mismatch as per #1# at #2#, knows SSI #3#, client to amend
Client has insufficient shares to deliver-This trade is contingent on purchase trade #1#
Client has insufficient shares to deliver-shares are on loan. LendingTeam to recall the shares
Client has insufficient shares to deliver
Instruction is too late for settlement, trade instructed after cutoff
Instruction is too late for settlement, trade instructed after cutoff
MBS Pool Fail, Pending receive from #1#
MBS Pool Fail, Pending receive from #1#
MBS Pool Fail, awaiting receipt of linked buy #1#
MBS Pool Fail, awaiting receipt of linked buy #1#
Market mismatch as per #1# at #2#, knows #3#, client to amend
No contact for counterparty to prematch. Please provide a broker contact to follow up
No contact for counterparty to prematch. Please provide a broker contact to follow up
Spoke to #1# at #2# and they will not prematch, #3#
Spoke to #1# at #2# and they will not prematch, #3#
PairOff. Spoke to #1# at #2# and they would like to pair off this trade with #4#. Client to advise
PairOff. Spoke to #1# at #2# and they would like to pair off this trade with #4#. Client to advise
Security mismatch as per #1# at #2#, knows #3#, client to amend
Physical team is awaiting to receive the security documents related to the trade
Physical trade awaiting documents, registration instruction or endorsements from #1# at #2#
Physical trade, awaiting courier reference from client. Client to advise
Physical trade, Stock with quantity #1# has been sent for splitting with shapes of #2#
As per Physical team securities are undergoing registration. Estimated completion #1#
Quantity mismatch as per #1# at #2#, knows #3#
Quantity mismatch as per #1# at #2#, knows #3#, client to amend
As per #1# at #2# securities registration request has been rejected by the transfer agent #3#
SSI mismatch as per #1# at #2#, knows SSI #3#
Pending restricted triparty: awaiting broker release letter
Pending restricted triparty: discrepancy in broker release letter
Direction of trade mismatch as per #1# at #2#, knows #3#, client to amend
SLRM adjustment, awaiting #1# at #2# to accept
SLRM adjustment approved-awaiting settlement
SLRM adjustment approved-awaiting settlement
Holding discrepancy, client has booked the trade in market #3# & we see the position held in market #3#
Holding discrepancy, client has booked the trade in market #3# & we see the position held in market #3#
Settlement terms mismatch as per #1# at #2#, counterparty knows #3#
Security mismatch as per #1# at #2#, knows #3#
TBA trade, failing due to #1#, client to advise
Trade date mismatch as per #1# at #2#, knows #3#
Trade date mismatch as per #1# at #2#, knows #3#, client to amend
Cash mismatch as per #1# at #2#, knows settlement amount #3#, client to amend #4#
Settlement date mismatch as per #1# at #2#, knows #3#, client to amend
Account mismatch as per #1# at #2#, counterparty to amend to match financial institution
Account mismatch as per #1# at #2#, knows #3#, client to advise
Account mismatch as per #1# at #2#, knows #3#, client to amend
SSI mismatch as per #1# at #2#, counterparty to amend to match financial institution
SSI mismatch as per #1# at #2#, knows #3#, client to advise
SSI mismatch as per #1# at #2#, knows #3#, client to amend
SSI mismatch as per #1# at #2#, knows SSI #3#, counterparty to amend to match financial institution
Affirmed with control number #1#
Counterparty DK's the trade as per #1# at #2# #3#
Counterparty DK's the trade as per #1# at #2# #3#
As per #1# at #2#, buy in procedures have been initiated at #1# on the trade
As per #1# at #2# buy in procedures have been initiated at #1# on the trade
Cash mismatch as per #1# at #2#, knows settlement amount #3# #4#
Cash mismatch as per #1# at #2#, knows settlement amount #3#, client to amend #4#
Cash mismatch as per #1# at #2#, knows settlement amount #3#, counterparty to amend
to match financial institution
Security mismatch as per #1# at #2#, knows #3#, counterparty to amend to match financial institution
Cash mismatch as per #1# at #2#, knows settlement amount #3#, counterparty to amend to
match financial institution
Quantity mismatch as per #1# at #2#, knows #3#, counterparty to amend to match financial institution
Market mismatch as per #1# at #2#, knows #3#, counterparty to amend to match financial institution
Settlement date mismatch as per #1# at #2#, knows #3#, counterparty to amend to match
financial institution
Direction of trade mismatch as per #1# at #2#, knows #3#, counterparty to amend to match
financial institution
Settlement terms mismatch as per #1# at #2#, counterparty knows #3#, counterparty to amend
to match financial institution
Trade date mismatch as per #1# at #2#, knows #3#, counterparty to amend to match financial institution
Pending credit check release due to insufficient funding. Client to advise
Pending credit check release due to insufficient funding. Awaiting proceeds from failing sale trade #1#
Pending credit check release due to insufficient funding. Client to advise
Pending credit check release due to insufficient funding. Awaiting proceeds from failing sale trade #1#
Partial settlement offered by #1# at #2# with quantity #3# cash #4#
Partial settlement offered by #1# at #2# with quantity #3# cash #4#
Contacted #1# at #2#, awaiting response
Contacted #1# at #2#, awaiting response
CUSIP is chilled in market. Checking with DTCC if the CUSIP #1# is eligible for frozen letter movement
CUSIP is chilled in market. Frozen letter initiated and working with CP to settle
CUSIP is chilled in market. Checking with DTCC if the CUSIP #1# is eligible for frozen letter movement
CUSIP is chilled in market. Frozen letter initiated and working with counterparty to settle
CUSIP is chilled due to Corporate action #1#
CUSIP is chilled due to Corporate action #1#
Counterparty has insufficient shares to deliver as per #1# at #2#
Prematched with #1# at #2# and they have agreed on the trade details
Settlement date mismatch as per #1# at #2#, knows #3#
Direction of trade mismatch as per #1# at #2#, knows #3#
Trade rejected due to minimum denomination issue, per market it should be #1#
and the par on trade is #1#
Trade rejected due to minimum denomination issue, per market it should be #1#
and the par on trade is #1#
Market mismatch as per #1# at #2#, knows #3#
Market mismatch as per #1# at #2#, knows #3#
Market mismatch as per #1# at #2#, knows #3#, client to amend
Market mismatch as per #1# at #2#, knows #3#, counterparty to amend to match financial institution
DRS/DWAC trade, transfer agent has rejected the instruction stating #1#
DRS/DWAC trade, No contact at Transfer Agent. Please provide contact for follow up
DRS/DWAC contacted #1# at #2# for an update-awaiting response
DRS/DWAC approved-Awaiting settlement
DRS/DWAC approved-Awaiting settlement
DTC adjustment trade, awaiting counterparty to accept as per #1# at #2#
Possible duplicate with trade #4#. Client to advise
Possible duplicate with trade #4#. Client to advise
Settlement terms mismatch as per #1# at #2#, counterparty knows #3#, client to amend
Future delivery date #1#
Future delivery date #1#
Inter account transfer, we are missing #1#
Incorrect buyer or seller, allegement in the market is from #1# at #2#, client to advise
Incorrect buyer or seller, trade booked with #1# but allegement in the market is from #1#,
client to advise
Counterparty has insufficient shares to deliver as per #1# at #2#
Client has insufficient shares to deliver, client to advise
Client has insufficient shares to deliver-This trade is contingent on purchase trade #1#
Client has insufficient shares to deliver-shares are on loan. Directed lending team to
recall the shares.
Client has insufficient shares to deliver-shares are on loan. Directed lending team to
recall the shares.
Client has insufficient shares to deliver-shares are on loan. Discretionary lending team to
recall the shares.
Client has insufficient shares to deliver-shares are on loan. Discretionary lending team to
recall the shares.
SSI mismatch as per #1# at #2#, knows SSI #3#, client to amend
Client has insufficient shares to deliver-This trade is contingent on purchase trade #1#
Client has insufficient shares to deliver-shares are on loan. Lending Team to recall the shares
Client has insufficient shares to deliver
Instruction is too late for settlement, trade instructed after cutoff
Instruction is too late for settlement, trade instructed after cutoff
MBS Pool Fail, Pending receive from #1#
MBS Pool Fail, Pending receive from #1#
MBS Pool Fail, awaiting receipt of linked buy #1#
MBS Pool Fail, awaiting receipt of linked buy #1#
Market mismatch as per #1# at #2#, knows #3#, client to amend
No contact for counterparty to prematch. Please provide a broker contact to follow up
No contact for counterparty to prematch. Please provide a broker contact to follow up
Spoke to #1# at #2# and they will not prematch, #3#
Spoke to #1# at #2# and they will not prematch, #3#
PairOff. Spoke to #1# at #2# and they would like to pair off this trade with #4#. Client to advise
PairOff. Spoke to #1# at #2# and they would like to pair off this trade with #4#. Client to advise
Security mismatch as per #1# at #2#, knows #3#, client to amend
Physical team is awaiting to receive the security documents related to the trade
Physical trade awaiting documents, registration instruction or endorsements from #1# at #2#
Physical trade, awaiting courier reference from client. Client to advise
Physical trade, Stock with quantity #1# has been sent for splitting with shapes of #2#
As per Physical team securities are undergoing registration. Estimated completion #1#
Quantity mismatch as per #1# at #2#, knows #3#
Quantity mismatch as per #1# at #2#, knows #3#, client to amend
As per #1# at #2# securities registration request has been rejected by the transfer agent #3#
SSI mismatch as per #1# at #2#, knows SSI #3#
Pending restricted triparty: awaiting broker release letter
Pending restricted triparty: discrepancy in broker release letter
Direction of trade mismatch as per #1# at #2#, knows #3#, client to amend
SLRM adjustment, awaiting #1# at #2# to accept
SLRM adjustment approved-awaiting settlement
SLRM adjustment approved-awaiting settlement
Holding discrepancy, client has booked the trade in market #3# & we see the position held
in market #3#
Holding discrepancy, client has booked the trade in market #3# & we see the position held
in market #3#
Settlement terms mismatch as per #1# at #2#, counterparty knows #3#
Security mismatch as per #1# at #2#, knows #3#
TBA trade, failing due to #1#, client to advise
Trade date mismatch as per #1# at #2#, knows #3#
Trade date mismatch as per #1# at #2#, knows #3#, client to amend
Cash mismatch as per #1# at #2#, knows settlement amount #3#, client to amend #4#
Settlement date mismatch as per #1# at #2#, knows #3#, client to amend
Incorrect or Invalid offset account. #1#
Insufficient holdings due to Lending-Curr Holdings #1# Pending Receive Qty #1# ETA for Settlement #1#
Trades are in unprocessed status due to an invalid market on trade. Client has provided #1#,
Client to advise correct market
Trades are in unprocessed status due to Insufficient Holdings in client account. Current Holdings #1#
FX Information is Invalid/missing. Client to provide correct FX information. #1#
Insufficient holdings due to COAC-Curr Holdings #1# Pending Receive Qty #1# ETA for Settlement #1#
Unprocessed due to closed/restricted account. #1#
Unprocessed due to no currency cash account
Trades are in unprocessed status due to missing settlement date. Client to provide settlement date
Trades are in unprocessed status due to future settlement date. Client has provided #1#,
Client to advise
Trades are in unprocessed status due to settlement date on holiday. Client has provided #1#,
Client to advise
Trades are in unprocessed status due to settlement date before trade date. Client has provided #1#,
Client to advise
Trades are in unprocessed status due to invalid settlement date. Client has provided #1#,
client to provide correct settlement date
Trades are in unprocessed status due to missing trade date. Client to advise
Trades are in unprocessed status due to future trade date. Client has provided #1#,
Client to advise
Trades are in unprocessed status due to trade date on holiday. Client has provided #1#,
Client to advise
Trades are in unprocessed status due to trade date after settlement date. Client has
provided #1#, Client to advise
Trades are in unprocessed status due to trade date after fund accounting start date.
Client has provided #1#, Client to advise
Trades are in unprocessed status due to duplicate instruction received. Client to advise. #1#
Trades are in unprocessed status due to original instruction not found. Client to advise. #1#
Missing offset account. #1#
Incorrect stamp information Client provided #1#, client to provide correct stamp information
Missing stamp information Client provided #1#, client to provide correct stamp information
Invalid net amount. Client provided #1#, client to advise correct net amount
Cancellation received, original instruction could not be found
Cancellation/Amenement received, multiple match found for original trade
Place of trade invalid or not recognized-Client sent #1#, client to advise correct PLACE OF TRADE
Place of listing invalid or not recognized-Client sent #1#, client to advise correct PLACE OF LISTING
Missing net amount. Client provided #1#, client to advise correct net amount
Incorrect net amount. Client provided #1#, client to advise correct net amount
Missing currency information. Client sent #1# client to advise correct currency #1#
Incorrect currency information, Client sent #1# client to advise correct currency #1#
Security Missing-Client sent #1#, client to advise correct security ID
Security not set up
Quantity is invalid. Client provided #1#, client to advise correct quantity
Lot size is invalid. Client provided #1#, client to advise correct lot size
Face Value is invalid. Client provided #1#, client to advise correct face value
Unprocessed status due to broker information. Client provided #1#, client to advise
correct broker information
Trades are in unprocessed status due to invalid trade date. Client has provided #1#,
client to provide correct trade date
Unprocessed as the market does not support contingency linking. Client has provided #1#,
Client to advise
Unprocessed trade due to linked transactions or TBAs
Broker Invalid, restricted or missing (ID/BIC/safe account number) #1#
Authentication reasons-BIC, source, linkages, senders message reference
Possible duplicate trade Duplicate Trade Reference #1#
Place of settlement invalid or not recognized-Client sent #1#, client to advise correct PSET
Insufficient holdings-Awaiting receipt for another purchase. Curr Holding #1#,
Pending Receive #1#, Pending Receive Trade Ref #2#
Transaction unprocessed due to #1#, client to advise
Invalid currency information. Client sent #1# client to advise correct currency #1#
Additional mandatory market specific information required #1#
Transaction has settled, cancellation has been denied. Original transaction ID #1#,
client to advise if this is a valid cancellation
Payment details invalid/missing #1#
Information provided on special instructions field
Multiple cancelations received, cancel is denied. Previous cancelation messages #1#,
Client to advise on messages
Invalid stamp information. Client provided #1#, client to provide correct stamp information
Invalid details or restricted holding #1#
Interest amount not allowed for security. Client supplied #1#, Client to provide correct interest amount
Repair-Insufficient holdings-Split across markets Current Holdings #1# Markets #1#
Security Invalid-Client sent #1#, client to advise correct security ID

Accordingly, with this technology, an optimized process for implementing methods and systems for validating a completeness and correctness of information required for a proposed transaction in order to facilitate a successful and timely settlement of the transaction is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than an of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover at such modifications, enhancements, and other embodiments which fan within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for validating a completeness and correctness of information required for a proposed transaction in order to facilitate a successful and timely settlement of the transaction, the method being implemented by at least one processor, the method comprising:
receiving from a user by the at least one processor, a request for a proposed transaction, the request including first information that relates to the proposed transaction;
determining, by the at least one processor, whether the first information is sufficient for executing the proposed transaction;
determining by the at least one processor, whether the first information includes at least one error that would prevent a successful execution of the proposed transaction;
when the first information is determined as sufficient for executing the proposed transaction and as not including the at least one error, validating by the at least one processor, the first information; and
when the first information is validated, transmitting, to the user by the at least one processor, a validation notification that the first information is validated for execution of the proposed transaction.

2. The method of claim 1, wherein the determining of whether the first information is sufficient for executing the proposed transaction includes applying a first algorithm that relates to a first machine learning technique to the first information.

3. The method of claim 2, wherein when the first information is determined as not sufficient for executing the proposed transaction, the method further comprises transmitting to the user, an insufficiency notification that additional information is required.

4. The method of claim 3, wherein the insufficiency notification includes second information that relates to a proposed action for supplementing the first information to be sufficient for executing the proposed transaction.

5. The method of claim 4, wherein the applying of the first algorithm includes providing historical transaction data as an input to the first algorithm, and generating the second information that relates to the proposed action as an output of the first algorithm.

6. The method of claim 1, wherein the determining of whether the first information includes the at least one error includes applying a second algorithm that relates to a second machine learning technique to the first information.

7. The method of claim 6, wherein when the first information is determined as including the at least one error, the method further comprises transmitting, to the user, an error notification that relates to the at least one error.

8. The method of claim 7, wherein the error notification includes third information that relates to a proposed action for remedying the at least one error such that the successful execution of the proposed transaction would not be prevented.

9. The method of claim 8, wherein the applying of the second algorithm includes providing historical transaction data as an input to the second algorithm, and generating the third information that relates to the proposed action as an output of the second algorithm.

10. The method of claim 1, wherein the first information includes at least one from among an identification of a security to be traded in the proposed transaction, a number of shares of the security to be traded in the proposed transaction, an amount of currency to be exchanged in the proposed transaction, and a timing for execution of the proposed transaction.

11. A computing apparatus for validating a completeness and correctness of information required for a proposed transaction in order to facilitate a successful and timely settlement of the transaction, the computing apparatus comprising:
a processor;
a memory; and
a communication interface coupled to each of the processor and the memory,
wherein the processor is configured to:
receive, from a user via the communication interface, a request for a proposed transaction, the request including first information that relates to the proposed transaction;
determine whether the first information is sufficient for executing the proposed transaction;
determine whether the first information includes at least one error that would prevent a successful execution of the proposed transaction;
when the first information is determined as sufficient for executing the proposed transaction and as not including the at least one error, validate the first information; and
when the first information is validated, transmit, to the user via the communication interface, a validation notification that the first information is validated for execution of the proposed transaction.

12. The computing apparatus of claim 11, wherein the processor is further configured to determine whether the first information is sufficient for executing the proposed transaction by applying a first algorithm that relates to a first machine learning technique to the first information.

13. The computing apparatus of claim 12, wherein when the first information is determined as not sufficient for executing the proposed transaction, the processor is further configured to transmit, to the user via the communication interface, an insufficiency notification that additional information is required.

14. The computing apparatus of claim 13, wherein the insufficiency notification includes second information that relates to a proposed action for supplementing the first information to be sufficient for executing the proposed transaction.

15. The computing apparatus of claim 14, wherein the processor is further configured to provide historical transaction data as an input to the first algorithm, and to generate the second information that relates to the proposed action as an output of the first algorithm.

16. The computing apparatus of claim 11, wherein the processor is further configured to determine whether the first information includes the at least one error by applying a second algorithm that relates to a second machine learning technique to the first information.

17. The computing apparatus of claim 16, wherein when the first information is determined as including the at least one error, the processor is further configured to transmit, to the user via the communication interface, an error notification that relates to the at least one error.

18. The computing apparatus of claim 17, wherein the error notification includes third information that relates to a proposed action for remedying the at least one error such that the successful execution of the proposed transaction would not be prevented.

19. The computing apparatus of claim 18, wherein the processor is further configured to provide historical transaction data as an input to the second algorithm, and to generate the third information that relates to the proposed action as an output of the second algorithm.

20. The computing apparatus of claim 11, wherein the first information includes at least one from among an identification of a security to be traded in the proposed transaction, a number of shares of the security to be traded in the proposed transaction, an amount of currency to be exchanged in the proposed transaction, and a timing for execution of the proposed transaction.
